(19) United States
(12) Patent Application Publication
(10) Pub. No.: US 2004/0050948 A1
(43) Pub. Date: Mar. 18, 2004

(54) Method and device for controlling odours

(76) Inventor: Frank Bartels, Dortmund (DE)

Correspondence Address: Kanesaka & Takeuchi, 1423 Powhatan Street, Alexandria, VA, 22314, US

(21) Appl. No.: 10/450,563

(22) PCT Filed: Dec. 14, 2001
(86) PCT No.: PCT/EP01/14803

(30) Foreign Application Priority Data
Dec. 15, 2000 (DE) 100 62 630.0
Apr. 18, 2001 (EP) 01109575.9

(51) Int. Cl. B05B 17/04

(52) U.S. Cl. 239/4; 239/102.2

(57) ABSTRACT

A method for producing or neutralising scents by means of fragrances being contained in a liquid medium substantially comprising three steps.

Collision of fluids containing fragrances under high pressure from a suitable nozzle into a downstream reactor thereby producing an aerosol cloud.

Providing means of transporting the aerosol cloud out of the reactor area and transporting the aerosol out of the reactor area.

According to a preferred embodiment of said method energy is provided in the downstream reactor so that a further diffusion of the aerosol occurs after leaving the nozzle.

Moreover: A suitable device for performing said method which particularly comprises a micro electromechanical element for supplying the fragrances in the reactor, and which comprises furthermore said means of transporting the aerosol out of the reactor; and according to a preferred embodiment said device further comprises a suitable power generator for providing the power for the retreatment of the fragrances in the reactor area.

The present invention relates to a method and a device for scent control.

Active scenting is playing an increasingly important role in information and communications technology and elsewhere. The reason is that scents act directly on the human sensitivities and are not filtered through the intellect like other sensory perceptions. In addition, scents can significantly influence human emotions and sensitivities. An active control of the scent of the human environment is therefore always of value if the sense of well-being is to be improved or changed by the removal of unpleasant scents and/or the addition of pleasant ones. This applies to all areas in which we pass relatively long periods, such as, for example, living and sleeping areas, workplaces, cars, etc. In addition, scents are increasingly being used in advertising technology to present product properties, a scent that promotes the product and at the same time characterizes it being supplied together with the product. In the multimedia sector and in cinemas, also, scents are increasingly being used in combination with sounds and images, the use of the scent increasing the consumer's attentiveness and the intensity of his perceptions in the absorption of information and entertainment.

Conventional techniques for emphasizing particular fragrances or for the deliberate elimination of scents operate, for example, on the same principle as inkjet printers, whereby a predetermined quantity of a liquid is sprayed into the air in the form of small droplets. However, the nozzles used for the dispensing of the liquid in such cases have such large apertures for the emergence of the liquid that, when the nozzle is not in operation, the liquid present in the nozzle aperture easily becomes caked. This problem has been solved in the case of inkjet printers by the development of inks with very low evaporation rates; this, however, is fundamentally impossible in the dispensing of fragrances because the fragrances are by their very nature intended to evaporate in the air. In addition, as a result of partial evaporation of the liquid during non-operation, the quality of the release of scent when the nozzle is operated again is lowered, because scents dissolved in liquids change easily at the air/liquid interface. In addition, by the conventional methods, droplets in the particle diameter range above approximately 10 μm are produced, which results in a disadvantageous reciprocal interaction between the droplets and also in a disadvantageous wetting of surfaces in the region where the droplets descend. Such systems for the dispensing of scents are therefore incapable of controlled use, especially where scent impressions are to be modified quickly.

In addition, the prior art has disclosed thermal vaporizers, which release a predetermined quantity of scent from a liquid reserve by increasing the temperature, this quantity of fragrance evaporating completely. The thermal vaporizers do produce fragrances in the form of very small particles, which do not cause disadvantageous wetting of surfaces in the near vicinity as readily as the methods described previously, with the associated disadvantages described previously. However, the systems based on increasing the temperature require particularly temperature-resistant fragrances, which substantially reduces the range of fragrance use and hence the use of these systems.

In summary, it may be stated here that existing methods and equipment for the reproduction of a scent are strictly limited in range and quality. In addition, the conventional methods, equipment and systems do not permit a mixing of individual fragrance oils, are insufficiently adjustable and produce a range of the air/scent flow that is too short for many applications. As a result, the scent impression that can be produced by the prior art is frequently distorted by the action of heat, scent transfers and chemical reactions.

The prior art document DE 42 36 037 A1 has also disclosed a nozzle body for the distribution of medicinal products which are intended to be absorbed into the lung. This nozzle body has been further developed by one of the applicants for the present invention in the unpublished German patent application No. 100 62 630.0 for use in a method for the production of scents, and that application also proposes an arrangement for the production of scents in which the nozzle likewise known from DE 42 36 037 A1 and the further developed nozzle in accordance with the above German patent application No. 100 62 630.0 are used.

The nozzle in accordance with DE 42 36 037 A1 does achieve droplets of an order of magnitude that seems suitable in principle for the use of the nozzle in the sector of scenting technologies. The droplets, however, are produced in the form of a stationary aerosol cloud, and in addition, when the nozzle alone is used to produce aerosols, it is not always ensured that complete vaporization or atomization of the fragrances will take place within a very short time.

It is therefore an object of the present invention to provide a device that makes it possible to dispense fragrances and/or scent destroyers selectively at the intended place of action while avoiding the disadvantages of the prior art described above. It is therefore a further object of the present invention to provide a method for the production of scents and/or a method for the destruction of scents from fragrances or scent destroyers contained in a liquid medium, which method avoids the disadvantages of the prior art described above and, in particular, is suitable for producing different scents.

It is therefore a particular object of the present invention to provide suitable means to reduce the size of the droplets and, in addition, to achieve a rapid transition into the gas phase, so that any transfer of fragrances within the systems to be created is very largely excluded, and changes of scent and limitations of effect can likewise be very largely excluded. It is also a further object of the present invention to indicate a device suitable for implementing the method.

The above objects of the present invention are achieved by the features of the claims.

Advantageous embodiments of the present invention are mentioned in the description that follows, which is accompanied by diagrammatic drawings. In the drawings:

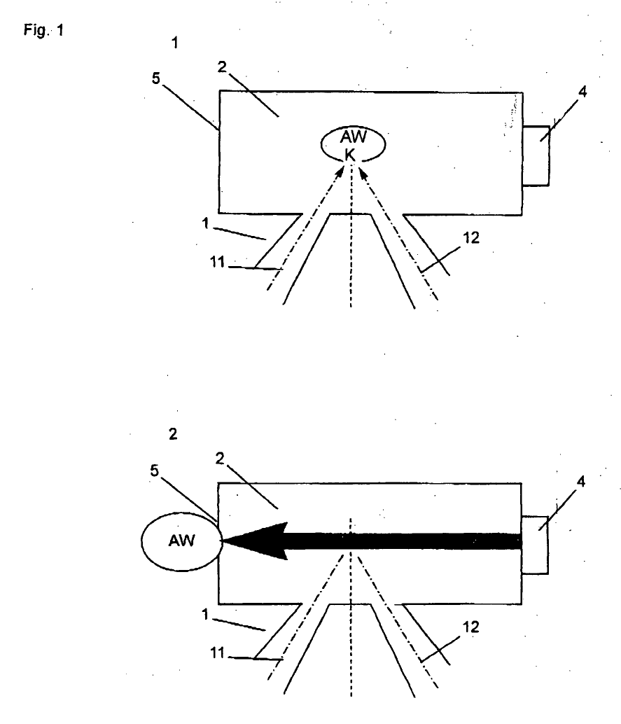

FIG. 1 shows a diagrammatic representation of the method steps of a first method according to the invention for producing scents and/or for destroying scents, wherein, suitably, a first device according to the invention for producing scents and/or destroying scents is used;

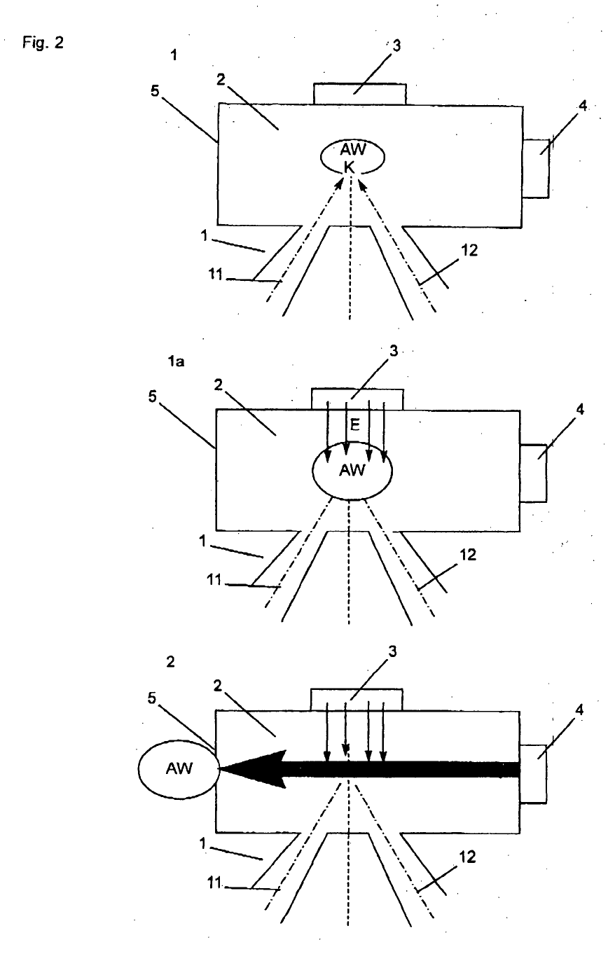

FIG. 2 shows an advantageous embodiment of the method in accordance with FIG. 1;

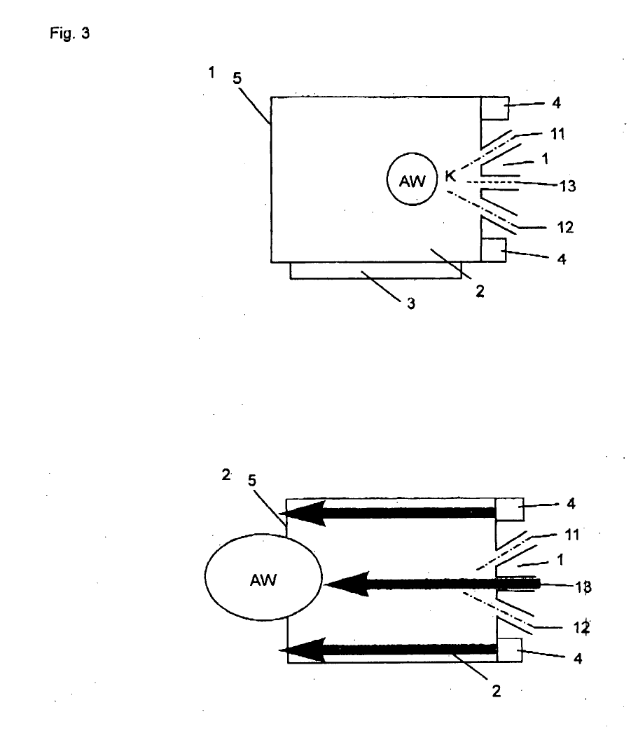

FIG. 3 shows a modification of the first method according to the invention, wherein, suitably, a second device according to the invention for producing scents and/or destroying scents is used;

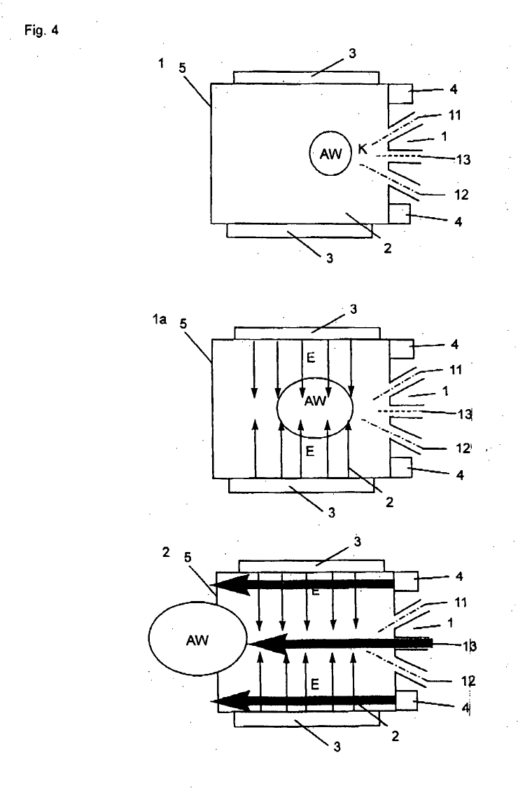

FIG. 4 shows an advantageous embodiment of the method in accordance with FIG. 2;

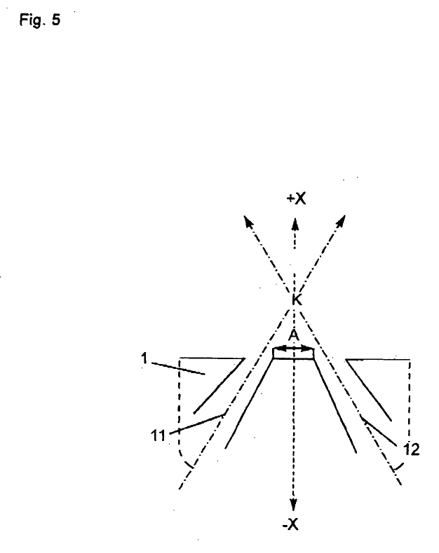

FIG. 5 shows a diagrammatic representation of a first nozzle according to the invention, which is suitably used in the methods in accordance with FIGS. 1 and 2, and FIGS. 3 and 4;

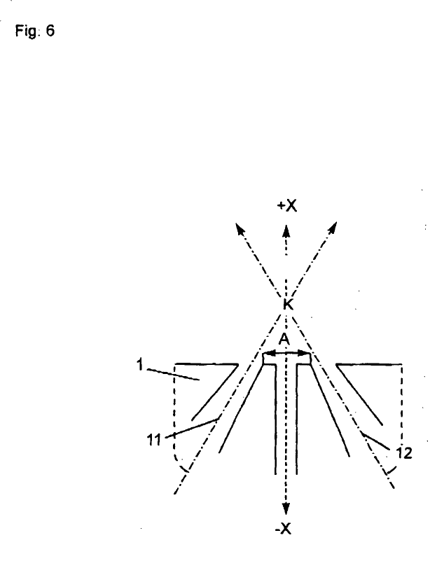

FIG. 6 shows a diagrammatic representation of a second nozzle according to the invention, which is suitably used in the methods in accordance with FIGS. 1 and 2, and FIGS. 3 and 4;

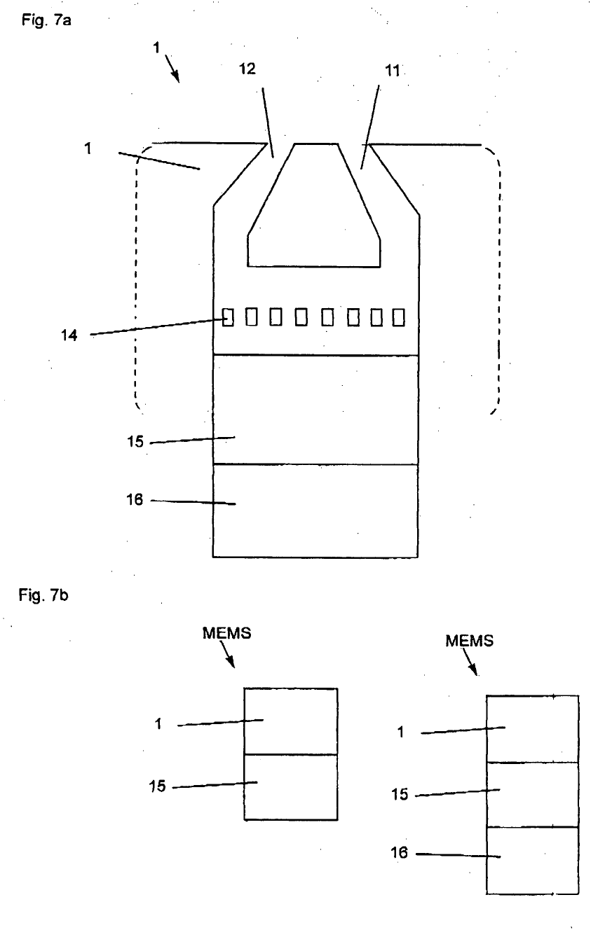

FIGS. 7a and 7b show a diagrammatic representation of a microelectromechanical part according to the invention, which essentially consists of two or three components, of which one component is a nozzle in accordance with FIG. 5 or 6;

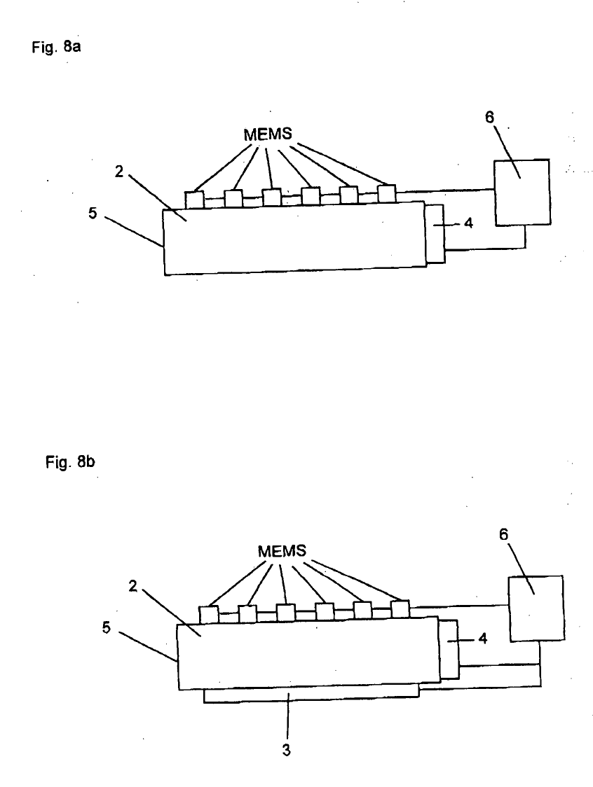

FIG. 8a shows a diagrammatic representation of a first arrangement according to the invention for the production of scents and/or destruction of scents, which is suitably used in the method in accordance with FIG. 1; and

FIG. 8b shows an advantageous embodiment of the arrangement according to the invention in accordance with FIG. 8a, which is suitably used in the method according to the invention in accordance with FIG. 2;

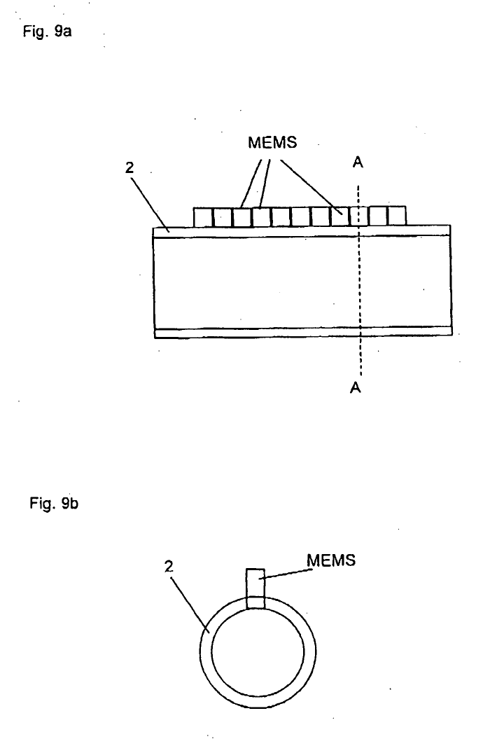

FIG. 9a shows a longitudinal section through a part-region of the arrangement in accordance with FIGS. 8a and 8b; and

FIG. 9b shows a cross section through the arrangement in accordance with FIG. 8 along the line A-A in FIG. 9a;

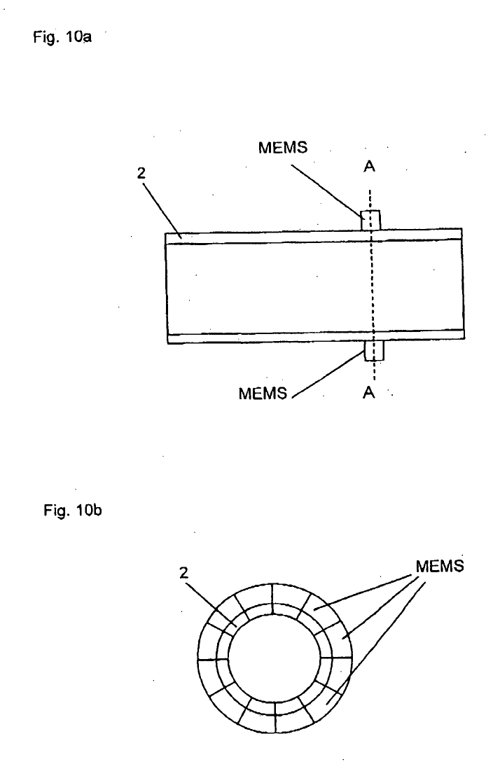

FIG. 10a shows a longitudinal section through a modification of the arrangement in accordance with FIG. 8; and

FIG. 10b shows a cross section through a modification of the arrangement in accordance with FIG. 8 along the line A-A in FIG. 10a; and

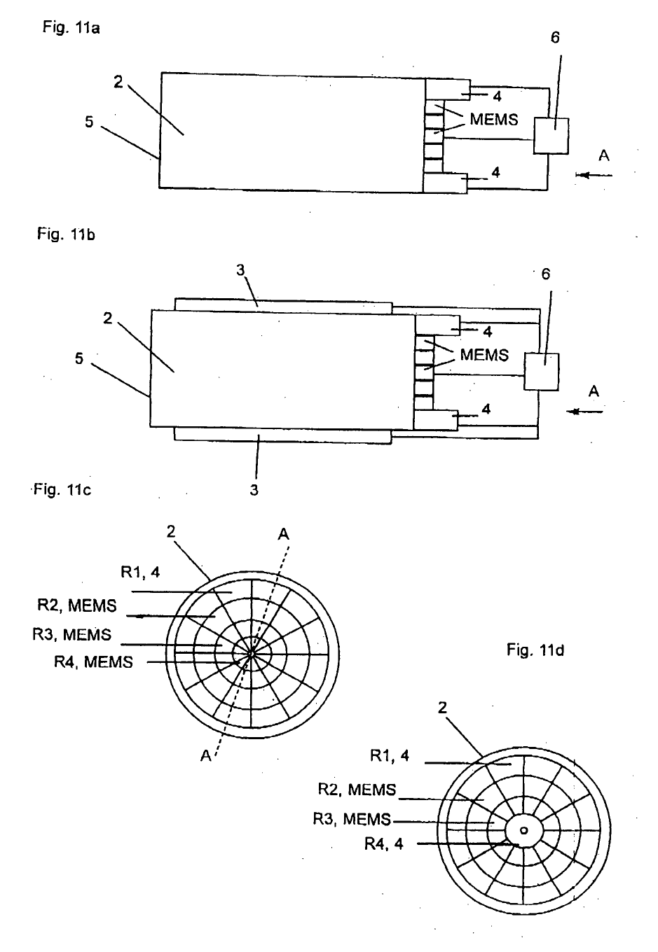

FIG. 11a shows a diagrammatic representation of a second arrangement according to the invention for the production of scents and/or destruction of scents, which is suitably used in the method in accordance with FIG. 3; and

FIG. 11b shows an advantageous embodiment of the arrangement according to the invention in accordance with FIG. 11a, which is suitably used in the method in accordance with FIG. 4;

FIG. 11c shows a section through the arrangement in accordance with FIG. 11a along the line A-A;

FIG. 11d shows a section through a modification of the arrangement in accordance with FIG. 11a along the line A-A in FIG. 11a.

The present invention is described below with reference to examples of embodiment.

It should be said here by way of introduction that, in addition to fragrances, the method according to the invention and the arrangement according to the invention can also advantageously be used to dispense substances with which scents/odors can be bound. These substances, known as clathrates, bond scents precisely at the points where the scent molecules are bonded in our noses, and thus mask the scent. Because the atomization unit advantageously atomizes these substances as well, this gives rise to special opportunities for scent modulation in enclosed areas by means of equipment constructed according to the invention. This is the circumstance meant when reference is made below to scent destruction.

It may therefore be said by way of introduction that when a method according to the invention or an arrangement according to the invention for the production of scents is referred to below, this is always to be interpreted as including a method or an arrangement, as the case may be, for the destruction of scents.

The basic concept of the present invention is to provide a device and a method for the production of scents from fragrances contained in a liquid medium or from liquid fragrances, wherein a large number of very small droplets with a predetermined maximum size is formed from the liquid medium and the fragrances within a predetermined time, so that the minimum size is of the order of magnitude of the molecules of the fragrances and the predetermined time is to be measured so that no interaction takes place between the airborne droplets and, in addition, direct wetting by fluids of surfaces in the vicinity of the droplets is excluded.

In the method according to the invention for the production of scents from fragrances contained in a liquid medium or from liquid fragrances, a large number of very small droplets with a predetermined size is formed according to the invention from the liquid medium and the fragrances within a predetermined time by means of collision of the liquid medium or the liquid fragrances, so that an aerosol cloud is formed. In accordance with an advantageous embodiment of the invention, a further diffusion of the aerosol of the aerosol cloud is produced by means of the action of energy on the aerosol cloud during its formation and/or shortly after its formation, so that the drop size of the aerosol is further reduced and direct wetting by fluids of surfaces in the vicinity of the droplets is thereby avoided, direct interaction between the droplets additionally being avoided and direct wetting by fluids of surfaces even at a greater distance also being avoided. The aerosol cloud so produced is thereupon dynamized, in other words conveyed to its site of action.

The present invention is also based upon the idea of producing fragrances by means of the provision of means suitable for the collision of the liquid medium, so that very small drop sizes are formed within a very short time. This can very advantageously take place initially as a result of self-collision of the liquid medium, but also advantageously initially as a result of collision of the liquid medium with a second liquid medium, which may likewise contain fragrances, and in addition this can initially take place by means of collision of the liquid medium with a gaseous medium. Even during the collision and/or shortly after the formation of the aerosol cloud produced by the collision, in an advantageous embodiment of the present invention, external energy is in addition transmitted to the aerosol cloud with an energy density that is suitable for further reducing the size of the droplets forming the aerosol cloud. A further effect of the introduction of energy is that the evaporation of the liquid medium cannot withdraw any energy from the environment, thus ensuring that the environment does not cool down. By means of the methods according to the invention, atomization of the fragrances takes place on the basis of drop sizes in the range from 3 to 5 μm. The effect of this is that, although scent molecules can precipitate on surfaces, droplets cannot and therefore cannot disadvantageously affect the scenting or rescenting by means of other fragrances. This is because scent molecules precipitated onto surfaces, unlike precipitated droplets, are harmless as regards the production of scents and also as regards the renewed production of other scents.

According to an advantageous embodiment of the method according to the invention, means are provided that also permit a high-frequency control of the operation of the method.

A further underlying concept of the present invention is the provision of a device suitable for implementing the above method which comprises at least one suitably structured nozzle, whose aperture is directed into a reaction chamber which is larger than the nozzle, a means for conveying the aerosol from the reaction chamber to its intended site of action also being provided on the reaction chamber. This reaction chamber itself is formed, according to the invention, as a nozzle, the aerosol cloud formed by the first, smaller nozzle described above in the interior space of the second nozzle formed by the reaction chamber being brought to the intended site of action from the second nozzle by the conveying means.

According to an advantageous embodiment of the present invention, suitable means are also disposed on the reaction chamber for producing a further diffusion of the aerosol after emergence from the nozzle by the provision of mechanical and/or electromagnetic energy.

By means of the abovementioned method according to the invention and the device according to the invention, it is possible to precipitate fragrances in very small particle sizes even without an increase in temperature and the abovementioned disadvantages associated therewith, so that the fragrances are used at their intended site of action. A further effect achieved is that the nozzle apertures can be of very small size, so that caking of the liquid at the nozzle apertures is avoided. A further effect of the present invention is that the fragrances are precipitated in such small drop sizes, of the order of magnitude of the molecules of the fragrances, that, in particular, the wetting with fluids of surfaces in the vicinity of a precipitated fragrance cloud is avoided. The device according to the invention and the method according to the invention are therefore also particularly suitable for precipitating different fragrances alternately and consecutively, or mixing various fragrances with one another, and/or precipitating fragrances and scent destroyers in alternation with one another, as no interference effects arise as a result of surfaces wetted with fragrances precipitated previously, especially within the reaction chamber provided downstream of the nozzle.

FIG. 1 shows a diagrammatic representation of a first embodiment of the method according to the invention for producing scents, wherein, in a first step, an aerosol cloud AW is produced by means of collision of fragrances contained in a liquid medium at a collision point K within a reaction chamber 2. This takes place, according to the invention, in that the liquid is brought into collision under high pressure from a nozzle 1 having at least two apertures. A suitable nozzle 1 is described below with reference to FIG. 5. In a second step 2 according to the invention the aerosol cloud AW is finally completely removed from the aperture 5 provided for this purpose in the reaction chamber 2, so that the reaction chamber 2 is completely emptied of fragrances, and in addition the aerosol cloud AW is thereby conveyed to its intended site of action. For this purpose, likewise, suitable means 4 disposed on the reaction chamber 2 are used to convey the aerosol cloud. According to an advantageous embodiment of the present invention, which is represented diagrammatically in FIG. 2, in a further step 1a according to the invention, the aerosol cloud AW produced in step 1 is also post-treated under the action of energy in the reaction chamber 2, a suitable energy producer 3 being used. As a result, as stated above, the droplets contained in the aerosol cloud AW are advantageously further reduced in size, and it is also ensured that no energy is drawn from the environment in the course of the evaporation of the fragrances. Moreover, the energy transfer E to the aerosol cloud AW ensures that no residual droplets of liquid precipitate on the interior surface of the reaction chamber 2.

In the method according to the invention in accordance with step 1 and step 2, and in accordance with step 1, step 1a and step 2 as shown in FIG. 1 and FIG. 2, which are described above, the aerosol cloud AW is conveyed away from the reaction chamber 2 in a suitable manner substantially perpendicularly to the emergence of the fragrances from the nozzle apertures 11 and 12 of the nozzle 1. A nozzle 1 suitable for use in the method in accordance with FIG. 1 and FIG. 2 is described in detail below in connection with the description of FIG. 5, and arrangements suitable for the method in accordance with FIG. 1 and FIG. 2 are explained in detail below with reference to the description of FIG. 6. According to the invention, in the method according to FIG. 1 and FIG. 2, steps 1 and 2, and steps 1, 1a and 2 respectively, are synchronized, it being possible, advantageously, for step 1 and step 2, and step 1, step 1a and step 2 respectively, to be launched simultaneously if a suitably slow-triggered means 4 is used to convey the aerosol cloud AW out of the reaction chamber 2. It is also advantageously possible, after the launching of step 1 and after the simultaneous launching of step 1 and step 1a, to launch step 2 with a predetermined slight delay, if a longer residence period of the aerosol cloud AW in the reaction chamber 2 is desirable. In order to ensure a uniform energy treatment of the fragrances AW in the reaction chamber 2, it may also be advantageous for step 2 to be launched after step 1 and/or step 1a is or are complete.

A second advantageous embodiment of the present invention is described below with reference to FIG. 3 and FIG. 4, this being a modification of the method according to the invention described above with reference to FIG. 1 and FIG. 2 and likewise essentially consisting of the method steps described above, step 1 and step 2, and step 1, step 1a and step 2 respectively, although in contrast to the method in accordance with FIG. 1 and FIG. 2, the means used for the collision 1, the means for the energy supply 3 used according to an advantageous embodiment of the present invention in accordance with FIG. 4 and the means used for conveyance 4 are disposed in a geometry relative to the reaction chamber 2 so that the nozzle 1 is disposed opposite to the aperture 5 of the reaction chamber, and that the removal of the aerosol cloud AW from the reaction chamber 2 with the means 4 provided for that purpose takes place substantially parallel to the nozzle emergence of the fragrances from the nozzle 1. This geometrical arrangement is particularly advantageous if only a few different fragrances are to be introduced from various nozzles 1 into the reaction chamber 2. It is clear, moreover, that the two methods according to FIG. 1 and FIG. 2, and FIG. 3 and FIG. 4 may also be advantageously combined with one another.

In the method in accordance with FIG. 3 and in accordance with FIG. 4, a nozzle is advantageously used which is explained in detail below with reference to the description of FIG. 6, and a suitable arrangement for the method in accordance with FIG. 1 and in accordance with FIG. 2 is explained in detail below with reference to the description of FIG. 11. It is also clear, however, that, instead of the nozzle in accordance with FIG. 6, the nozzle in accordance with FIG. 5 may be used, which equally applies conversely to the methods in accordance with FIG. 1 and FIG. 2.

FIG. 5 shows a diagrammatic representation of a nozzle 1, which is advantageously used in the method according to the invention in accordance with FIG. 1 to FIG. 4, wherein at least two jets of liquid 11, 12 are directed under high pressure at a collision point K. The level of the pressure and the thickness of the jets in this case are so calculated that the collision at point K results in a very fine atomization of the liquid medium and a drop size of the order of magnitude of the molecules of the fragrances contained in the liquid medium. In the drawing, the two jets of liquid enclose an angle of, for example, approximately 60 degrees. It is clear that the angle may be varied within a range, provided that steps are taken to ensure, first, that at the point of collision between the two jets of liquid droplets having kinetic energy in the positive X-direction are predominantly formed, so that rebound effects of the droplets are very largely avoided, and secondly provided that the angle between the directions of the two jets is such as to ensure an adequate collision between the jets. In other words, as the angle increases so the collision potential also desirably increases, but at the same time rebound effects also increase because of the shifting of the collision point K in the negative X-direction. According to the invention, suitable angles therefore lie in a range between 30° and 120°, advantageously between 45° and 90°.

When the nozzle 1 in accordance with FIG. 5 is used in the methods according to the invention in accordance with FIG. 1 to FIG. 4, therefore, this ensures that the surface of the colliding medium does not wet a surface of the reaction chamber, and that the droplets initially formed on collision are so small that they evaporate to molecules under the action of energy E in the reaction chamber 2 within a very short time immediately following the collision. The effect of this is that only scent molecules, not droplets, can precipitate on the interior wall of the reaction chamber 2 and on more remote surfaces and therefore cannot disadvantageously affect the scenting or rescenting by means of other fragrances.

The methods according to the invention described above with reference to FIG. 1 and FIG. 2, and FIG. 3 and FIG. 4, and the nozzle according to the invention in accordance with FIG. 5 are particularly suitable for the self-collision of a liquid medium and/or the collision of two liquid media with various fragrances and/or with a liquid medium which contains a fragrance with a neutral liquid medium and/or a liquid medium with a gaseous medium.

FIG. 6 shows a modification according to the invention of the nozzle in accordance with FIG. 5, wherein, in addition to the two jet paths 11 and 12, a third jet path 13 is likewise directed toward the collision point K. In this case, the jet 13 is formed in a suitable manner in the plane defined by the two jets 11 and 12, and is moreover oriented in a suitable manner along the bisector of the angle between the two channels 11 and 12. With regard to the magnitude of the angle between the two channels 11 and 12 and with regard to the distance A between the jets 11 and 12, directed toward one another at an angle, what was stated above with regard to FIG. 5 applies again here, with the difference that, because of the jet 13, more kinetic energy in the positive X-direction is available, and the optimum angle is correspondingly larger than can be chosen in the embodiment according to FIG. 5. With regard to the distance A between the apertures of the two outer channels 11 and 12, which in this case, as in the embodiment of the nozzle 1 described a above, determine the direction of the two outer jets 11 and 12, what was stated above with regard to the first embodiment of the nozzle 1 according to the invention applies in the same way to the second embodiment of the nozzle 1 according to the invention described here.

The second embodiment of the nozzle 1 according to the invention is particularly suitable for atomizing a liquid medium which contains a fragrance by means of self-collision via the two jets of liquid 11 and 12 and also by means of a third jet of liquid 13, and/or, furthermore, in collision with a second liquid medium containing a second fragrance and/or a gaseous medium, which is directed along the jet 13. According to the invention, it is optionally possible for the same and/or different liquid and/or gaseous media, which may optionally contain the same and/or different fragrances, to be passed along the jets 11 and 12 and 13 to collide at point K.

FIG. 7a shows an enlarged portion of the aperture of the nozzle 1 according to the invention in accordance with FIG. 5, the further course of the channels 11 and 12 also being shown, these opening into a greatly enlarged channel region in which, in a suitable manner, filter structures 14 may be formed which help to prevent clogging of the channels 11 and 12, especially at their apertures, by any impurities in the liquid medium. A widening of the cross section of the channels is particularly advantageous for the achievement of a high output pressure of the liquid medium. It is clear that FIG. 7a refers to an embodiment of the method according to the inventions which causes atomization of the liquid medium by means of self-collision of the liquid medium.

The pressure required for atomization of the liquid medium is generated in a suitable manner by means of a part 15 installed upstream of the nozzle 1, and likewise miniaturized, which may in a suitable manner form a single part with the nozzle 1 and is advantageously provided by means of a piezoelectric actor. Piezoelectric actors are particularly suitable as means for generating pressure, as they can build up the pressure necessary for the collision and atomization without generating heat, can be produced in miniaturized form and are high-frequency switchable. Also installed upstream of the piezoelectric actor 15 is a suitably formed flexible container 16, which serves as a storage container for the liquid medium and, in a suitable manner, is so formed that replenishment with air as the liquid level falls is excluded. According to the invention, moreover, the nozzle 1, means for applying pressure 15 and storage container 16 are so formed that the entry of air into the system comprising the nozzle 1, means for applying pressure 15 and storage container 16 is excluded. As is shown diagrammatically in FIG. 7b, in a suitable manner, the nozzle 1 and means for applying pressure 15 are provided by means of a microelectromechanical system (MEMS) as a miniaturized part, and it is also possible, in a suitable manner, for the nozzle 1, means for applying pressure 15 and storage container 16 to be in the form of an MEMS.

The MEMS according to the invention described above and shown in diagrammatic form in FIGS. 7a and 7b have been explained by way of example with reference to a single-substance nozzle in accordance with the design shown in FIG. 7a, which brings about the self-collision of a liquid medium. According to the invention for two-substance or multi-substance of the design in accordance with FIG. 5 and FIG. 6, appropriately modified MEMS are provided in the same way.

FIG. 8a shows a diagrammatic representation of a device according to the invention for implementing the method according to the invention in accordance with FIG. 1, in which, according to the invention, at least one microstructured MEMS is disposed on a reaction chamber 2 in a manner such that the microstructured nozzle 1 of the MEMS part is directed into the reaction chamber 2. A ventilator and/or compressed air producer 4 is also disposed on the reaction chamber 2, and provides an airflow to convey the aerosol AW from the aperture 5 of the reaction chamber 2. For the control of the MEMS, the energy producer for the further diffusion 3 and the conveying means 4, a suitable electronics system 6 is also provided, which controls the arrangement in accordance with the methods according to the invention as described above. The reaction chamber 2 here, according to the invention, is formed as a second, larger nozzle 2, in whose interior space an aerosol cloud is produced by means of the first, smaller nozzle 1, this being brought from the second, larger nozzle 2 by means of suitable conveying means 4 disposed at the second nozzle 2 to its intended site of action. This nozzle structure according to the invention, which consists of a first, small nozzle that produces an aerosol cloud in the interior of a second nozzle, is particularly advantageous for the dispensing of fragrances, because the formation of the aerosol and the conveying of the aerosol are advantageously separated from one another.

FIG. 8b shows a diagrammatic representation of an advantageous embodiment of the arrangement according to the invention in accordance with FIG. 8a, in which, in addition, a suitable compressed air and/or ultrasonic and/or electron flow and/or microwave producer is or are disposed on the reaction chamber 2 to provide mechanical and/or electromagnetic energy for the further diffusion of the aerosol AW downstream of the nozzle outlet.

According to the invention a plurality of mutually independent MEMS for the dispensing of the same fragrances, different fragrances, neutral substances or scent destroyers can be disposed in a suitable manner on the reaction chamber 2, the MEMS being capable of being triggered independently of one another by the electronic system 6 according to the invention, so that they can be switched simultaneously and/or at intervals in time.

The reaction chamber 2 has a volume that is very much greater than the aperture of a nozzle 1 of an MEMS part and may for example be, in accordance with the diagrammatic arrangement shown in FIGS. 8a and 8b, of cylindrical form, the MEMS in the arrangement described here being disposed, In a suitable manner, in a linear formation on the shell of the cylinder, and conveying means 4 being disposed opposite the aperture 5 on the base of the cylinder. The reaction chamber 2, which is very much larger than a nozzle aperture of the MEMS, is also designed in such a size, as a function of the structure and arrangement of the MEMS and the mechanical, electromagnetic and fluidic properties of the liquid medium, that the aerosol AW is not precipitated on its internal wall.

The means 3 for generating energy for the post-treatment of the aerosol in the reaction chamber 2, in the advantageous embodiment in accordance with FIG. 8b, is likewise disposed on the shell of the cylinder, and, in a suitable manner, in the form of a compressed air and/or ultrasonic and/or electron flow and/or microwave producer with the characteristic frequency of the liquid medium, so that the energy required for a further diffusion of the aerosol in the reaction chamber 2 can be provided within a short time. The reaction chamber 2 is also suitably matched to the frequency of the ultrasonic and/or electron flow and/or microwave producer in such a way that a stationary wave can be provided within the reaction chamber 2 by means of the producer 3. In addition, the reaction chamber 2 advantageously consists of a conductive material, its internal wall being formed in a suitable manner from material that is inert to air or passivated.

The MEMS may comprise single-substance nozzles in accordance with FIG. 5 and/or two-substance nozzles in accordance with FIG. 6, the MEMS with two-substance nozzles, which also feed compressed air into the reaction chamber 2, can be disposed in such a way that each time at least one MEMS is activated, all the other MEMS that have a compressed air nozzle simultaneously feed compressed air into the reaction chamber 2. As a result, wetting of the internal wall of the reaction chamber 2 is further prevented. In addition, a plurality of further MEMS parts for the dispensing of compressed air can be disposed at suitable positions on the reaction chamber, so that an airflow can be formed over the internal wall of the reaction chamber 2.

FIG. 9a shows an advantageous linear arrangement of the MEMS on the wall of the reaction chamber 2 in longitudinal section, and FIG. 9b shows a cross section through the reaction chamber 2 along the line A-A in FIG. 9a. A linear arrangement of the MEMS is particularly advantageous, because it can be inexpensively produced in a simple manner, and moreover because the storage containers 16 for the fragrances can be simply replaced or replenished with this arrangement.

FIG. 10a shows a modification of the device according to the invention in accordance with FIG. 8, in which the MEMS are disposed in a circular manner on a reaction chamber 2, in longitudinal section, and FIG. 10b shows a section through the line A-A in FIG. 10a. In a suitable manner, the MEMS are here disposed in a ring, which is also replaceable as a unit. As a result, production costs are likewise reduced and the operation of the device is also facilitated, simple retrofitting being possible. Furthermore, this arrangement permits the provision of suitable prefabricated sets of scents, each of which comprises a combination of suitable scents in the annular arrangement, each of which can be disposed simply in the device according to the invention. It is clear that an arrangement according to the invention may also contain a plurality of such rings. It is also clear that the MEMS may advantageously also be arranged helically on the reaction chamber 2, and that the MEMS may also b disposed uniformly over the surface of the cylindrical shell of the reaction chamber 2.

FIGS. 11a, b, c and d shows diagrammatic representations of a device according to the invention, which is suitable for implementing the method according to the invention in accordance with FIG. 2. The devices according to the invention in accordance with FIG. 11 substantially correspond to the devices described above in accordance with FIGS. 8a and b, with the difference that the MEMS are disposed opposite the aperture 5 of the reaction chamber 2 at the base of a reaction chamber 2 which is likewise cylindrical by way of example, the MEMS sharing the base surface with the conveying means 4 for conveying the aerosol cloud out of the reaction chamber 2. Otherwise, the arrangement substantially corresponds to the device in accordance with FIG. 8 described above, so that the relevant description is incorporated here by way of reference.

The reaction chamber 2 here, according to the invention, is again formed as a second, larger nozzle 2, in whose interior space an aerosol cloud is produced by means of the first, smaller nozzle 1, this being brought from the second, large nozzle 2 by means of suitable conveying means 4 disposed at the second nozzle 2 to its intended site of action. This nozzle structure according to the invention, which consists of a first, small nozzle that produces an aerosol cloud in the interior of a second nozzle, is particularly advantageous for the dispensing of fragrances, because the formation of the aerosol and the conveying of the aerosol are advantageously separated from one another.

The MEMS of the device in accordance with FIG. 11 may also be formed as a single-substance nozzle and/or a two-substance nozzle in accordance with FIG. 5a and FIG. 6 respectively, their triggering corresponding to the triggering described above for the MEMS of the arrangement in accordance with FIG. 8, which is therefore again incorporated here by way of reference. In the arrangement according to the invention in accordance with FIG. 11, use can particularly advantageously be made of an MEMS having a two-substance nozzle, one of whose channels is a compressed air channel, in which case, with suitable triggering of the compressed air of the MEMS, it is also possible to dispense with the additional means 4 for conveying the aerosol cloud out of the reaction chamber 2. It is, however, also advantageous, in addition to the MEMS, to provide suitable means 4 for conveying the aerosol cloud out of the reaction chamber 2, these means, in a suitable manner, being disposed on an outer ring R1, 4 of the cylinder base, and being provided in a simple manner by means of suitable holes in the cylinder base and a single ventilator disposed downstream of the MEMS. As a result of this arrangement, advantageously, precipitation of the fragrances on the internal cylinder wall is further prevented. The MEMS are distributed uniformly, in a suitable manner, over the cylinder base, and in addition to the conveying means 4 at the edge of the base, additional conveying means 4 may also be disposed, for example, at the centre of the base R4, 4, as is shown in FIGS. 11c and 11d.

With the method according to the invention in accordance with FIGS. 1 and 2, and FIG. 3 and FIG. 4, as described above and the arrangements according to the invention in accordance with FIGS. 8 and 11, it is possible in a simple manner to set the quantity of fragrances to be dispensed by each MEMS during each working period in a wide range between 1 picogram and 100 μl. Moreover, the duration of the working period of scent dispensing can be adjusted comparatively within a very wide range, and the time lag between two scent dispensing actions may be very short or zero, so that scents can also be selectively mixed with one another. In this case, the control is provided via electronic pulses or electronic data processing programs and causes a predetermined quantity and/or composition of a scent, the dispensing of which can be synchronized with other events: a time may be preselected and also set for regular intervals. The devices described above in accordance with FIGS. 8 and 11 may also contain suitable sensors, which cause the electronic control system 6, when, for example, they detect optical, acoustic, thermal or other signs, to activate a particular scent dispensing action in a predetermined manner; it is also possible for the control system to be provided with a feedback function, which may again interact with a sensor.

The device according to the invention is particularly suitable for portable and/or permanently installed equipment that can be used in the office, home or workplace, or for promotional purposes, for example in retail outlets to improve the ambient air by dispensing fragrances and other substances, it being possible for the dispensing to be synchronized with other media events. The device according to the invention is also advantageously so designed that it can be linked to other electrical or electronic equipment or can communicate with other electrical or electronic equipment. For example, it can be in radio contact with film projection equipment. The device is also advantageously designed to be controlled by other electrical or electronic equipment, and can be integrated into other electrical or electronic equipment or can form a unit with such equipment. Suitable equipment for this purpose includes, preferably, information and communications technology equipment, such as, for example, television receivers, radios, mobile and other telephones, computers, multifunctional information and communications equipment, etc, and also equipment that is used in hygiene, environmental, domestic, automotive and air-conditioning technology, such as, in particular, disinfection equipment, air-conditioning units, evaporation equipment, atomizers and humidifiers.

By means of the methods according to the invention and the arrangements according to the invention the disadvantages of the prior art described initially are avoided, as is apparent from the detailed description given above of the advantageous embodiments of the present invention.

1. A method for producing and/or neutralising scents by means of fragrances and/or scent destroyers being contained in a liquid medium or liquid fragrances and/or scent destroyers comprising the following steps:
step 1:
autocollision of said fragrances and/or scent destroyers and/or collision of said fragrances and/or scent destroyers with compressed air and/or collision of said fragrances and/or scent destroyers with a liquid of neutral scent by means of supplying said fragrances and/or scents destroyers and/or compressed air and/or liquid of neutral scent under high pressure out of a suitably formed miniaturized nozzle (10) into a reactor (2), located downstream of said nozzle (10), thereby producing an aerosol cloud (AW);
step 2:
providing means (4) for transporting said aerosol (AW) from said reactor (2) and transporting said aerosol cloud (AW) out of said reactor (2).

2. A method according to claim 1, further comprising:
step 1a:
supply of energy (E) in said downstream reactor area (2) so that a further diffusion of said aerosol (AW) occurs after leaving said nozzle;

3. A method according to claim 1 and 2, whereby
said means (MEMS, 3, 4, 6) are selected such that said means permit high frequency control of said step 1 and said step 2 or said step 1, step 1a and step 2.

4. A method according to one of claims 1 to 3, whereby
said nozzle (1) is formed so that no air can penetrate into the interior of said nozzle (1).

5. A method according to one of the aforesaid claims 1 to 4, whereby
said means (4) in said step 2 are provided via a compressed air source and/or a ventilator, and
an airflow being produced for transporting said aerosol (AW) out of said reactor (2).

6. A method according to one of the aforesaid claims 2 to 5, whereby
said energy (E) in said step 2 being provided by a compressed air source and/or a ventilator and/or an electron current and/or microwaves and/or acoustic waves.

7. A method according to one of claims 1 to 6, whereby
said step 1 and said step 2 is switched synchronously, and whereby said step 1 and said step 2 being started simultaneously and/or said step 2 being started with a predetermined slight delay and/or said step 2 being started after said step 1 is terminated.

8. A method according to one of the aforesaid claims 2 to 7, whereby
said step 1 and said step 1a and said step 2 are switched synchronously and said step 1 and said step 1a and said step 2 are started simultaneously and/or said step 1 and said step 1a are started simultaneously and said step 2 is started with a predetermined slight delay, and/or said step 2 is started after said step 1 is terminated and/or said step 1a and said step 2 and/or said step 1a and said step 2 is carried out so long as said aerosol has been completely transported out of said reactor area.

9. A device for performing said method according to one of the aforesaid claims comprising:
at least one micro structured nozzle (1), the mouth thereof being directed into said reactor area (2) which is larger than said nozzle (1); and
suitable means (4) of transporting said aerosol (AW) out of said reactor to the location of their effect being mounted to said reactor (2), so that the following nozzle structure is being provided:
a first minor nozzle (1) is mounted on a second major nozzle (2) so that the formation of said aerosol occurs in the interior (2) of said major nozzle (2) via said nozzle (1); and
said aerosol (AW) from said second nozzle (2) being capable of being supplied to its location of effect.

10. A device according to claim 9, further comprising:
suitable means (3) of providing mechanical and/or electromagnetic energy for producing a further diffusion of said aerosol (AW) after leaving said nozzle (1) are arranged at the reactor area (2).

11. A device according to claim 10, further comprising:
a piezoelectric actuator (15) for said means of producing pressure which is suitably arranged before said nozzle mouth;
suitably formed flexible containers (16) for supplying said liquid medium are arranged before said nozzles which prevent an introduction of air at sinking liquid level;
as said means (3) for further diffusion of said aerosol (AW) a suitable air pressure and/or ultrasonic and/or electron current and/or microwave generator is arranged at said reactor (2);
as said means for transporting (4) an additional ventilator and/or air pressure generator is arranged to said reactor thus providing an air flow for transporting said aerosol out of said reactor; and
furthermore, said device comprises a suitable electronic circuit (6) for controlling said means of generating pressure (15), said means for further diffusion (3) a and said means for transporting (4).

12. A device according to one of claims 9 to 11, further comprising:
said nozzle (1) having at least two nozzle mouths (11, 12) being directed in such a way that jets of said liquid medium leaving said nozzle mouth collide close to said nozzle mouths at a collision point (K).

13. A device according to one of claims 9 to 11, further comprising:
said nozzle (10) having at least two nozzle mouths (11, 12) being arranged in such a way that jets of said liquid medium leaving said nozzle mouths (11, 12) and a compressed air jet leaving a second nozzle mouth (11, 12) collide close to said nozzle mouth at a collision point (K).

14. A device according to one of claims 12 and 13, further comprising:
said nozzle (10) having at least three nozzle mouths (11, 12, 13) being arranged in such a way that jets of said liquid medium leaving said nozzle mouths (11, 12) and a compressed air jet leaving another nozzle mouth (13) collide close to said nozzle mouth at a collision point (K).

15. A device according one of claims 11 to 14, further comprising;
said compressed air and/or supersonic and/or electron current and/or microwave generator is formed in accordance with the respective characteristic frequency of said liquid medium in such a way as to cause within a short period of lime a further diffusion of said aerosol (AW).

16. A device according to one of claims 11 to 15, further comprising:
said reactor (2) being constructed in a sufficiently dimensioned way depending on the structure and arrangement of said nozzle (10) and the mechanic, electromagnetic and fluidic characteristics of said liquid medium so that said aerosol does not condense at the inner wall of said reactor (2); and
said reactor (2) being sufficiently tuned to the frequency of said supersonic and/or electron current and/or microwave generator, such that a standing wave is capable of being formed inside said reactor (2).

17. A device according to one of claims 9 to 16, further comprising:
said reactor (2) consisting of a conductive material and its inner surface being composed of scent inert and/or passivated material.

18. A device according to one of claims 9 to 17, comprising a plurality of independently controllable elements (MEMS) each comprising at least said nozzle (1) and said actuator (15) and which are formed in such a way, that no air can penetrate into the interior of said elements (MEMS), which are linearly, circularly or spirally arranged to said reactor (2).

19. A device according to one of claims 9 to 18 comprising further nozzles (1) for supplying compressed air which are arranged to said reactor (2) in such a way as to provide an air flow above said inner wall of said reactor (2) so that precipitation on the inner wall is further prevented.

20. A device according to one of claims 9 to 19 comprising:
a multitude of 2 to 1000 different fragrances and/or scent destroying substances being provided in containers which are separated from each other, whereby an individual element (MEMS) for emitting said fragrance or said scent destroyer is provided for every scent and/or scent destroyer.

21. A device according to one of claims 9 to 20 comprising an electronic control circuit (6) controlling the amount of fragrances emitted per element (MEMS) per work interval in the range between 1 picograms and 100 milligrams, and
the period of time of the work interval used for emitting scent is capable of being controlled in a very wide range, whereby the time sequence between two steps of emitting fragrance can be very short or zero so that scents can be mixed selectively;
said control circuit is capable of being feasible via electronic signals or programs, whereby said control circuit can also be provided with a feed back function and can be activated by a sensor; and
said control circuit achieves a predetermined quantity and/or composition of the scent; and
said emission can be effected synchronously with other events; and
said emission may have a predetermined time setting; and
said periodical emission can be controlled periodically.

22. A device according to one of claims 9 to 21 comprising:
said device being a portable and/or residently installable apparatus capable of being used in living areas and/or offices and/or households and/or work places and/or public places and/or catering trade and/or for promotion purposes, for example in commerce for amelioration of the air in rooms by emitting fragrances and other substances.

23. A device according to one of claims 9 to 22, whereby
said device is a portable and/or residently installable apparatus emitting fragrances and other substances synchronously with other media events.

24. A device according to one of claims 9 to 23, whereby:
said device is capable of being coupled to other electric or electronic apparatus or is constructed so that said device can communicate with other electric or electronic apparatuses; or
said device can be controlled via other electric or electronic apparatus; or
said device forms a unity together with other electric or electronic apparatus, or
said device is integrated to other electric or electronic apparatus, whereby
said other apparatus are preferably apparatus being used in communication technology and information technology, such as particularly TVs, radios, phones, mobile phones, computers; and/or whereby
said other apparatus are in particular apparatus being used in hygiene, environmental, house, vehicle and air condition technology, like especially disinfection apparatuses, air condition apparatuses, humidifying apparatuses, atomising apparatuses and moistening apparatuses.
